(19) United States
(12) Patent Application Publication
(10) Pub. No.: US 2016/0125393 A1
(43) Pub. Date: May 5, 2016

(54) VIRTUAL CARD

(71) Applicant: Calay Venture S.à r.l., Bettembourg (LU)

(72) Inventor: Cevat Yerli, Frankfurt am Main (DE)

(21) Appl. No.: 14/534,065

(22) Filed: Nov. 5, 2014

(51) Int. Cl. G06Q 20/34; G06Q 20/32; G06Q 20/40

(52) U.S. Cl. CPC G06Q 20/351; G06Q 20/4012; G06Q 20/322

(57) ABSTRACT

A method includes providing a virtual card in a memory of a mobile device, wherein the virtual card comprises user information, establishing a data connection between the mobile device and a terminal device, authenticating a user of the virtual card, and transferring a result of the authentication to the terminal device in order to activate commands of the terminal device.

### FIELD OF INVENTION

The present disclosure relates to a method for the use and management of one or more virtual cards.

### BACKGROUND

Most individuals are now issued with a vast array of different types of plastic cards by their bank, credit card provider, frequent flyer program, customer loyalty program, car park provider, employer, gym, library, etc. Carrying such a large quantity of cards in a wallet is very inconvenient for users, as are the current methods for accessing the end service(s) associated with these cards.

### SUMMARY AND INITIAL DISCLOSURE

This disclosure exploits the opportunities that mobile devices (e.g., smart phones), wireless networks, and associated server systems, etc., can offer to make the use and management of cards easier and much more convenient between users and service providers alike.

In one aspect, a method is provided comprising steps of providing a virtual card in a memory of a mobile device, wherein the virtual card comprises user information; establishing a data connection between the mobile device and a terminal device; authenticating a user of the virtual card; and transferring the result of the authentication to the terminal device in order to activate commands of the terminal device.

In another aspect, a method for creating a virtual card is provided, comprising steps of recording a digital image of a document; processing the image in order to retrieve user information; transferring the user information to a server device; and creating the virtual card by associating the user information with the virtual card.

In yet another aspect of the disclosure, a computer program product comprising executable instructions is stored on a non-transitory computer-readable medium and, when executed by a processor, the computer program product causes the processor to perform steps of providing a virtual card in a memory of a mobile device, wherein the virtual card comprises user information; establishing a data connection between the mobile device and a terminal device; authenticating a user of the virtual card; and transferring the result of the authentication to the terminal device in order to activate commands of the terminal device. The computer program product can be stored in a memory of the mobile device for execution by a processor of the mobile device. With the virtual card, data provided on a plastic (real-world) card is stored. The virtual card can be considered a set of data that comprises user information. User information may comprise the following: name of the user (e.g., first name and/or last name), card number, expiration date of the card, a security code of the card, a provider of the card, a current balance of the (credit) card, and a combination thereof. User information may be encrypted. Information about all executed transactions may be provided. The information can be shown on a display device of the mobile device.

The disclosure relates to a method that can be called “Secure Frictionless Authentication.” Typical plastic or real-world card examples include credit cards, bank cards, employee identity cards, customer loyalty cards, club membership cards, library cards, and in fact any type of card that implies a transaction between a cardholder and third parties. Using the virtual card, all financial or security sensitive transactions can be processed on a secure “Frictionless Authentication System.”

One or more virtual cards, each comprising the same or different user information, can be stored in the memory of the mobile device. Each virtual card can be associated with a real-world card. Each virtual card can be associated with one of several terminal devices for enabling an authentication of the user for the specific terminal device. Several virtual cards can be shown on the display device of the mobile device, for example, in the form of a list. A virtual card may be selected via a user input, for example, using an input device of the mobile device. Operations for managing the virtual cards can be provided, for example, a virtual card can be deleted, further information about the virtual card can be displayed, and/or an order of several virtual cards can be adapted.

The terminal device can also be called a downstream device. It may be connected to an upstream device that is adapted to provide further functions and/or commands. The upstream device can be an automatic teller machine (ATM), a payment device, a vendor's smart device, or another device of an end service, e.g., a reader/terminal in a gym, at a library, or at the entrance to a car park, etc. Once established, the Secure Frictionless

Authentication connection triggers the server-side communication chain and permits a connection of the mobile device to the system as a whole. In respect to financial transactions, this can comprise a connection of the ATM, the payment device or specific payment gateway, and onwards through an established network, i.e., a payment server through card processors to an issuing bank and back through the same chain to either confirm or decline a transaction. In the case of a non-financial transaction, the exact elements are dependent on the specific end service sought and of that organization's own systems/methods that are required and used. However, in all cases the Secure Frictionless Authentication process can provide the connection between the mobile device, the terminal device, and thereafter to the necessary and specific upstream elements (e.g., a server device) of the particular end service being sought.

In one instance, a virtual card can be created, for example, using a scanning device (e.g., a camera) of the mobile device. A digital image of a card, such as a plastic card, can be created. The image can be processed, for example, by the processor of the mobile device, in order to obtain user information. The user information can be sent to a server device for further processing, for example, by a processor of the server device. Once the server device has processed the data received, it can transfer back the processed data to the mobile device for confirmation and acceptance purposes. Once these processes are complete, the virtual card can be created and stored in the memory of the mobile device and is available for use.

The data connection between the mobile device and the terminal device can be established when a distance between the mobile device and the terminal device is less than a predetermined value. The distance between the mobile device and the terminal device can be determined using a geolocation procedure. A geolocation procedure is, for example, the global positioning system (GPS). The global positioning system is a space-based satellite navigation system that provides location and time information, anywhere on or near the Earth where there is a line of sight to some, e.g., four or more,

GPS satellites. The mobile device and/or the terminal device each may comprise a GPS receiver which is adapted to access the GPS system. Alternatively, other location methods may be used for determining the distance between the mobile device and the terminal device, for example, iBeacon technology. iBeacon is a trademark of Apple Inc. for an indoor proximity system which enables the mobile device, e.g., a smart phone, to perform actions when in close proximity to an iBeacon. In another embodiment, near-field communication (NFC) technology can be used for establishing a connection when the mobile device and the terminal device are in close proximity to each other. NFC is a set of standards for (mobile) devices to establish wireless communication with each other by touching them together or bringing them into close proximity, usually no more than a few centimeters.

The step of authenticating the user may comprise a step of entering a personal identification number (PIN) or a password. The mobile device can comprise an input device in order to receive input from the user. The input device can be a keyboard connected to or integrated in the mobile device. Alternatively, the input device can be a touch sensitive screen (touch screen) of the mobile device. The input device can also be an image capturing device (e.g., a camera) or a sound capturing device (e.g., a microphone).

If several virtual cards are stored in the memory of the mobile device, a master password, and/or a master PIN can be provided. Entering the master password/PIN can enable authentication for every virtual card, thus simplifying the need for the user to have to remember many different passwords and/or PINs for each of his cards.

The step of authenticating the user may comprise steps of recording and analyzing a fingerprint of the user, for example, by a fingerprint sensor of the mobile device. One or more fingerprints of the user can be evaluated in order to establish authentication.

The step of authenticating the user may comprise steps of recording and analyzing a sound sample. Both the mobile device and the terminal device may be connected to a server device. The server device may provide a sound sample to be expected to the terminal device, e.g., via a look-up table for the sound sample. The terminal device may go into listening mode, e.g., by activating a sound capturing device (i.e., a microphone). Further, the server device may transfer the selected sound sample to the mobile device. The sound sample can be replayed by the mobile device, e.g., via a speaker. The sound sample can be recorded by the terminal device. After recording, the sound sample can be processed by a processor of the terminal device in order to compare it with the expected sound sample and complete authentication. The sound sample may comprise a sound, a ring tone, and/or a vibration. The step of authenticating the user may comprise steps of recording and analyzing a signature of the user. The signature entered in the mobile device and/or the terminal device is compared to a signature stored on the server device.

The step of authenticating the user may comprise steps of recording and analyzing a user action. In this case, the server device may generate a required user action. The user action may be a randomly generated action so as to not always be the same and may consist of an action such as, but not limited to, a gesture, swipe, shake, or other physically based action that the user is required to undertake through or on the mobile device. The required action must be fulfilled within a pre-determined time-frame, e.g., 10 seconds or 20 seconds, otherwise the request for authentication will be terminated. The user may be shown a demonstration of what he must undertake on the display device of the mobile device before he is expected to start the actual user action process. The mobile device may comprise a motion sensor, e.g., an acceleration sensor, which is adapted to determine a movement and/or an orientation of the mobile device. The user action may be determined via the motion sensor.

The step of authenticating the user may comprise steps of providing an image of the user and analyzing the image. An image of the user may be displayed on a display device of the terminal device. The image may be transmitted by the server device to the terminal device.

The terminal device may be adapted to initiate a transfer of money after successful authentication of the user. As mentioned above, the virtual card may correspond to a real world credit card. After authentication, a payment can be performed using the user information of the virtual card.

The method for creating a virtual card may comprise steps of transmitting the virtual card to a mobile device and storing the virtual card in the memory of the mobile device.

The method for creating a virtual card may comprise a step of transferring the digital image to the server device. The digital image may be stored in a memory of the server device.

The present disclosure refers to the usage of a mobile device, a terminal device, and a server device. Each device may comprise one or more processors or processing components configured to execute instructions. Further, each device may comprise a memory in form of volatile memory (e.g., RAM—random access memory) and/or non-volatile memory (e.g., a magnetic hard disk, a flash memory). Each device may further comprise means for connecting and/or communicating with other devices, for example, by a wired connection (e.g., LAN—local area network, Firewire (IEEE 1394), and/or USB—universal serial bus) or by a wireless connection (e.g., WLAN—wireless local area network, Bluetooth, near filed communication (NFC) and/or WiMAX—Worldwide Interoperability for Microwave Access). Each device may comprise a device for registering user input, for example, a keyboard, a mouse, and/or a touch pad. Each device may comprise a display device. Alternatively, each device may be connected to a display device. The display device may be a touch-sensitive display device (e.g., a touch screen).

The virtual card can also be used manually. In this scenario, the user can be remote from the terminal device, a typical example being an online order and subsequent payment using a credit or bank card. The user may select the appropriate virtual card from those stored on the mobile device. The user can initiate readiness by telling the server device through the virtual card application that he wants to use a specific card. On receiving this information, the server device can determine which end service the user is requesting and can process the necessary system elements applicable to the particular end service required. The remaining process depends on the end service being requested.

### BRIEF DESCRIPTION OF THE DRAWINGS

The specific features, aspects and advantages of the present disclosure will be better understood with regard to the following description and accompanying drawings where:

FIG. 1 shows a flow chart of a virtual card creation;

FIG. 2 shows a flow chart of a shopping transaction;

FIG. 2a shows a shopping server-side process;

FIG. 3 shows a flow chart of an ATM transaction;

FIG. 4 shows a flow chart of a user picture verification process;

FIG. 5 shows a flow chart of a sound sample confirmation process;

FIG. 6 shows a flow chart of a manual selection of a virtual card; and

FIG. 7 shows a flow chart of a non-financial transaction.

### DETAILED DESCRIPTION

In the following description of exemplary embodiments, reference is made to the drawings which show, by way of illustration, specific embodiments. It is to be understood that the embodiments may include changes in design and structure without departing from the scope of the present invention as defined in the claims.

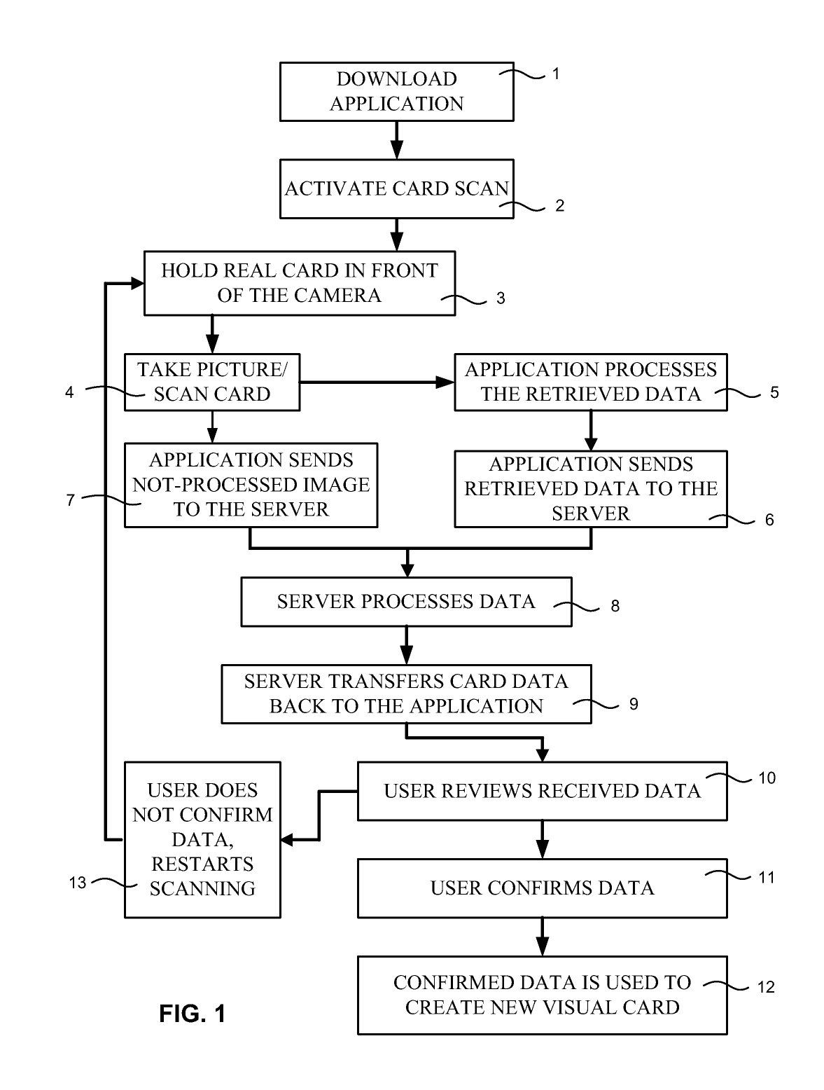

FIG. 1 shows a flow chart for creating a virtual card. In step 1, an application (software) is downloaded from a server device to a mobile device, e.g., a smart phone. After installing the software on the mobile device, the application is started in step 2. A user holds a real card, e.g., a credit card, in front of a camera of the mobile device (step 3). In step 4, an image of the card is taken, e.g., using the camera of the mobile device. The image can be stored in a memory of the mobile device. Further, the image is scanned to retrieve data. Text recognition algorithms may be used for analyzing the image. In step 5, the application processes the retrieved data. Then, the retrieved data is transmitted to the server device for further processing (step 6). In addition or alternatively, the non-processed image can be transmitted to the server device (step 7). The server device processes the data and/or image received, e.g., by a processor of the server device, and creates card data comprising user information (step 8). The card data is transferred back to the mobile device (step 9). In step 10, the user reviews the received card data to check whether it is correct. If the user confirms the card data in step 11, the card data is used for creating the virtual card (step 12). If the card data is not confirmed (step 13), the method repeats with step 3. Once these processes are complete, the virtual card is available for use. The virtual card can be stored in the mobile device.

In the following description, several embodiments (use cases) for using the virtual cards are disclosed. A mobile device of a user can also be called a user device.

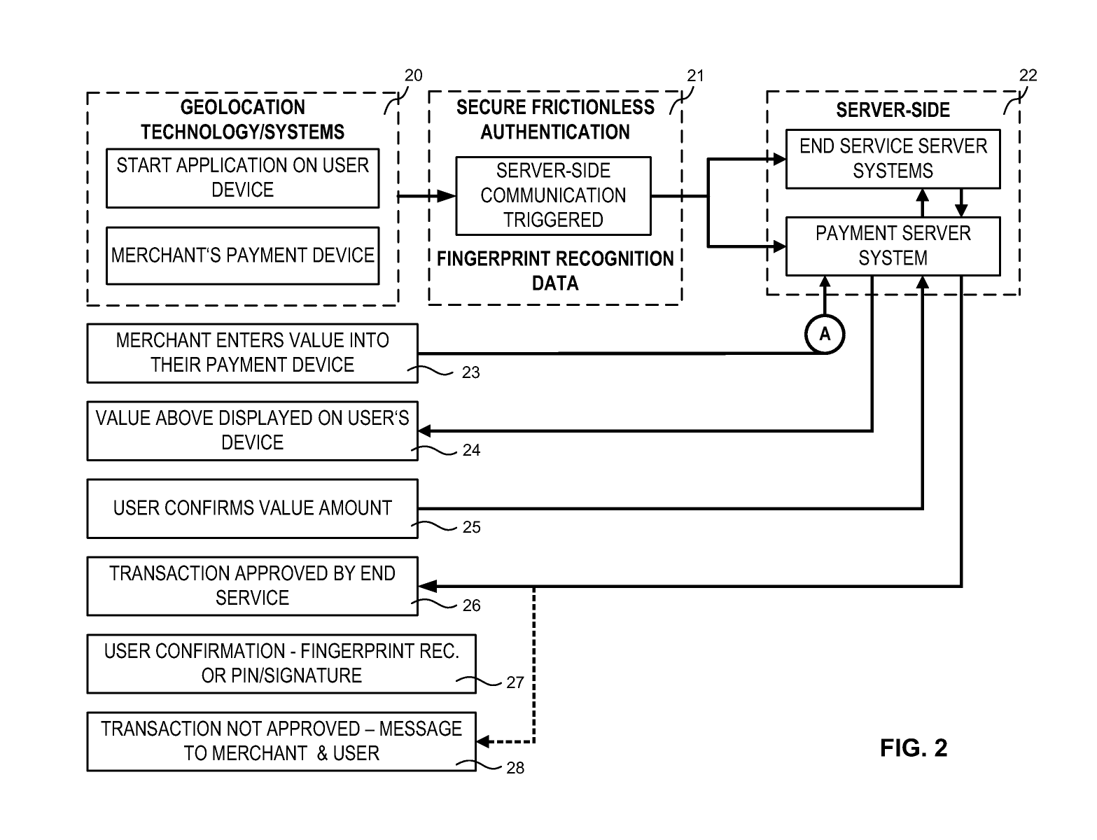

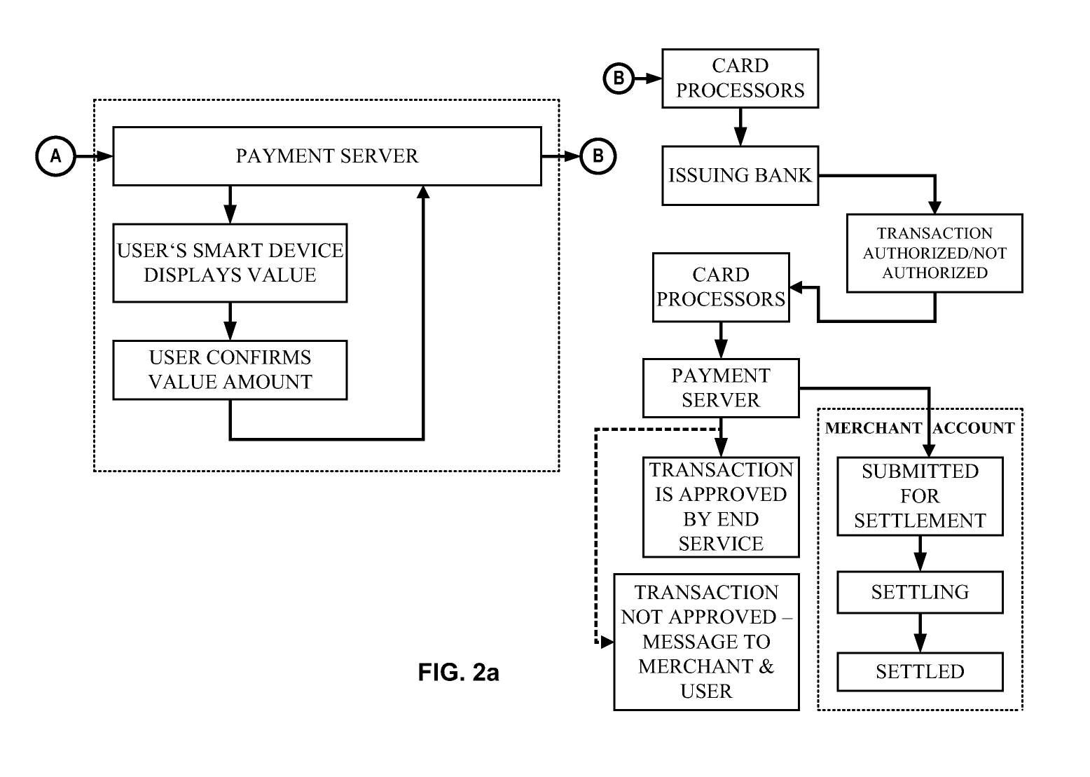

Use Case I (FIGS. 2 and 2a)—Shopping Transaction

A user wishes to buy an item in a shop. The user selects one of several of the virtual cards to be used for payment. The mobile device with the virtual card is brought into close proximity to a payment device of the merchant. Using geolocation technology, a distance between the mobile device and the payment device is determined (20). Secure Frictionless Authentication between the two devices is started if the distance is less than a predetermined value (21). Starting Secure Frictionless Authentication triggers a server-side communication process. Hereby, a communication chain between the various parties and devices involved in financial transactions, i.e., the payment device, a payment server, card processors, and an issuing bank, is started (22). It is checked whether the mobile device supports fingerprint recognition. If fingerprint recognition is supported, this information is sent during the Secure Frictionless Authentication process to the other devices. Alternatively, a request for fingerprint recognition can be asked for later in the transaction process, e.g., by a request to “submit fingerprint info now.” Once a connection with the selected virtual card has been established, the value of the transaction is entered by the merchant into the payment device (23). The merchant's payment device then communicates with the payment server and the payment server communicates with the mobile device to display the value amount just entered by the merchant on the display of the mobile device (24). In step 25, the user confirms the value amount, e.g., by using an input device of the mobile device. These actions set in motion the known communication chain between the payment server, card processors, and the issuing bank (downstream) as well as back from the issuing bank, the card processors, the payment server and the mobile device (upstream) to ensure that the payment is authorized, confirmed and the merchant paid (FIG. 2a). Once the transaction is authorized by the bank (26) and confirmed by the user via fingerprint recognition (27), the transaction can be completed. Alternatively, if fingerprint recognition is not available, a PIN or a signature can be used for authentication and confirmation. If the transaction is not approved, a message is sent to the merchant and/or the user, e.g., via the payment device and the mobile device, respectively (28).

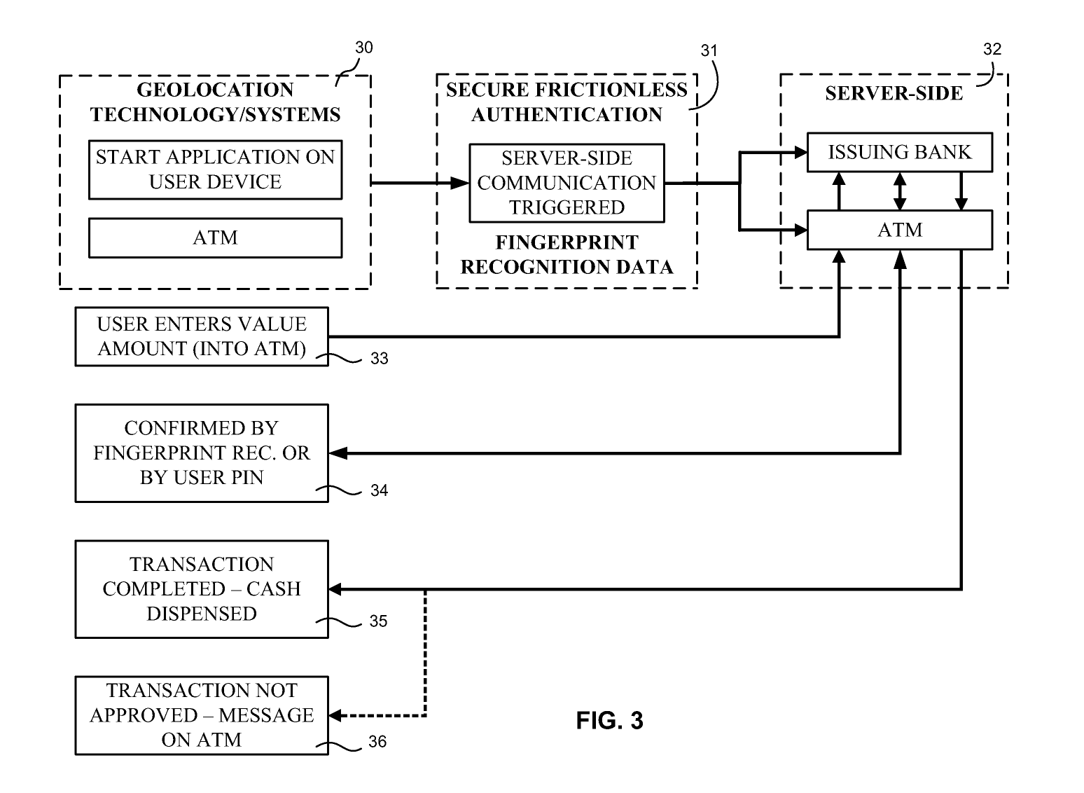

Use Case II (FIG. 3)—ATM Transaction

A user brings the mobile device with the virtual card into close proximity to the ATM (30). Secure Frictionless Authentication occurs between the two devices (31). This triggers the server-side communication that sets in motion the normal communication chain between the various parties and devices involved in such a transaction, i.e., the ATM, the issuing bank, and back to the ATM (32). If fingerprint recognition is supported, this information is sent during the Secure Frictionless Authentication process. Alternatively, a request for fingerprint recognition can be asked for later in the transactional process by a request to “submit fingerprint info now.” The value of the transaction is input into the ATM by the user (33). This triggers the downstream server-side communication, i.e., from the ATM to the issuing bank and from the issuing bank back to the ATM (32). Authentication of the user is performed by fingerprint recognition or by entering a PIN (34). Further downstream server-side communication occurs, i.e., from the ATM to the issuing bank and back from the issuing bank to the ATM (32). In step 35, the cash is dispensed by the ATM. If the transaction is not approved, a message is shown on the ATM (36).

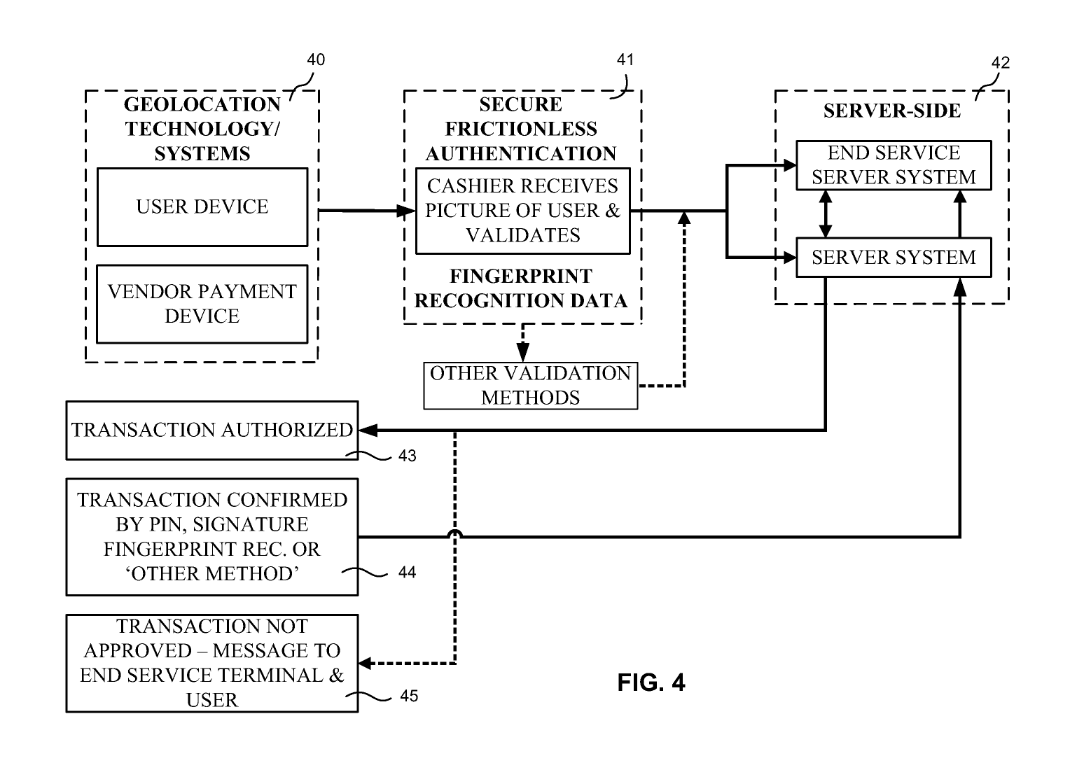

Use Case III (FIG. 4)—Shopping Transaction

Geolocation technology enables the user's mobile device and a payment device of a vendor to connect with each other (40). This can be achieved before or during the placing of the purchased goods through a cash till. Once the connection is established, the cashier receives a picture or photo of the user on the payment device (41). The cashier validates the picture/photo (assuming the picture is of the user). By this validation, the downstream server action (the Secure Frictionless Authentication process) is started (42). Other embodiments can include the cashier taking and storing a picture of the user to further enhance security and anti-fraud measures. In another embodiment where the cashier may not be present, a camera may validate the user's identity by taking a photo and comparing it automatically to a profile photo on a server. Once the payment value is known (goods processed through the till) and the payment value has been authorized by the user's bank/credit card provider (43), the user confirms the payment at the till with a PIN, a signature, a fingerprint, or a simple acceptance such as an “Ok” button, etc. (44).

In a further embodiment, the transaction can be completed without any further confirmation by the user to create the most frictionless shopping and payment experience possible. It should be noted that regardless of the transaction confirmation method used or not used, the user can be shown information on a display device of the payment device. The information can include the user's picture/photo, his name, and the value of the transaction being processed. This provides the user with the security that the amount charged is correct. Furthermore, the same information further including the vendor's information and the shopping list can be available on the user's mobile device after the transaction has been processed. If the transaction is not approved, a message is sent to the payment device and/or the mobile device (45).

The same system and method (using photos/pictures) can also be applied between two users in close proximity who want to exchange money.

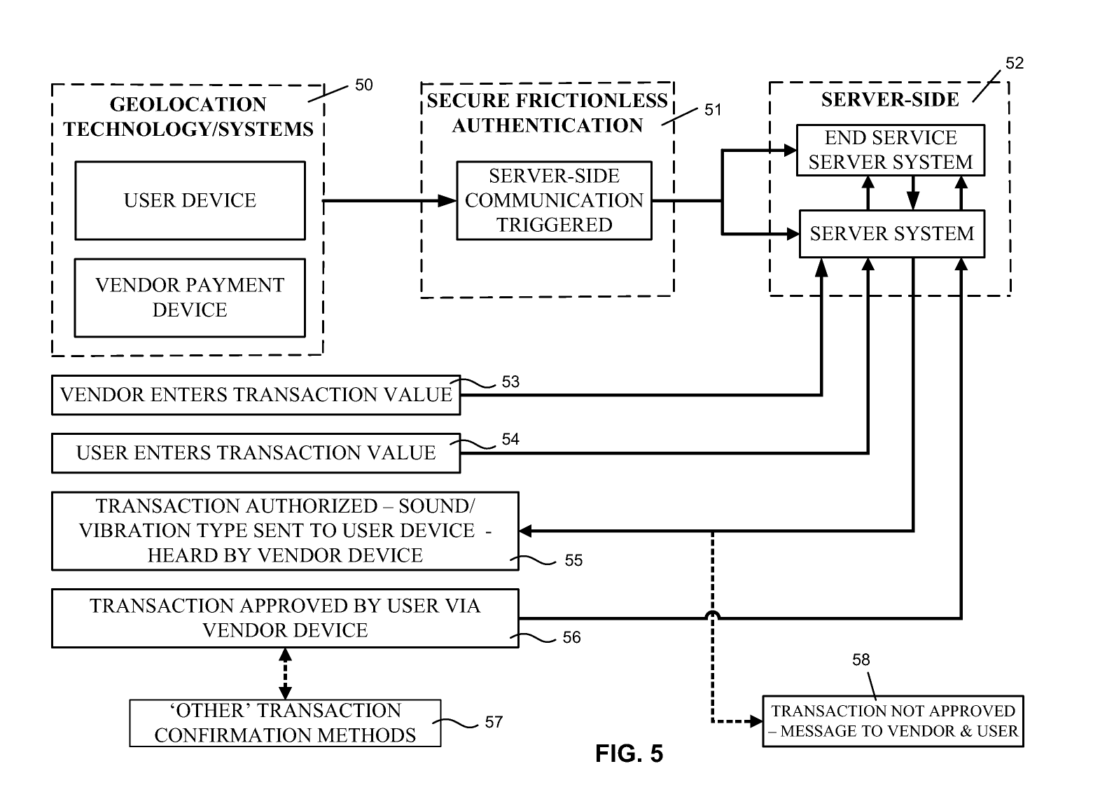

Use Case IV (FIG. 5)—Shopping Transaction

The geolocation technology enables the connection of a mobile device and a payment device of a vendor to each other (50). Secure Frictionless Authentication occurs between the two devices (51). This triggers the server-side communication (52). Once the connection is established, the vendor and the user both enter the value of the transaction into their respective devices—these can be concurrent or near concurrent actions (53 and 54). Both sets of data are then sent to a server (52). From the vendor's side, the server is requesting a sound/vibration type, e.g., via a look-up table. The vendor's payment device then goes into listening mode, e.g., by activating a microphone. At the same time, the server is processing the request made by the user and is setting the established chain of requests in motion. Once payment authorization has been given, the server sends the sound/vibration type it has selected to the user's mobile device. The mobile device replays the sound/vibration, e.g., by a speaker. Because the payment device is in listening mode, it can determine and analyze the sound/vibration type (55). The user can then confirm the transaction via a display on the payment device (56) or using any other confirmation method described above (57). If the transaction is not approved, a message is sent to the payment device and/or the mobile device (58).

It should be noted that the validation process can comprise processing timing and/or a time window for analyzing the sound/vibration type. The sound/vibration type can be changed every few minutes for added security.

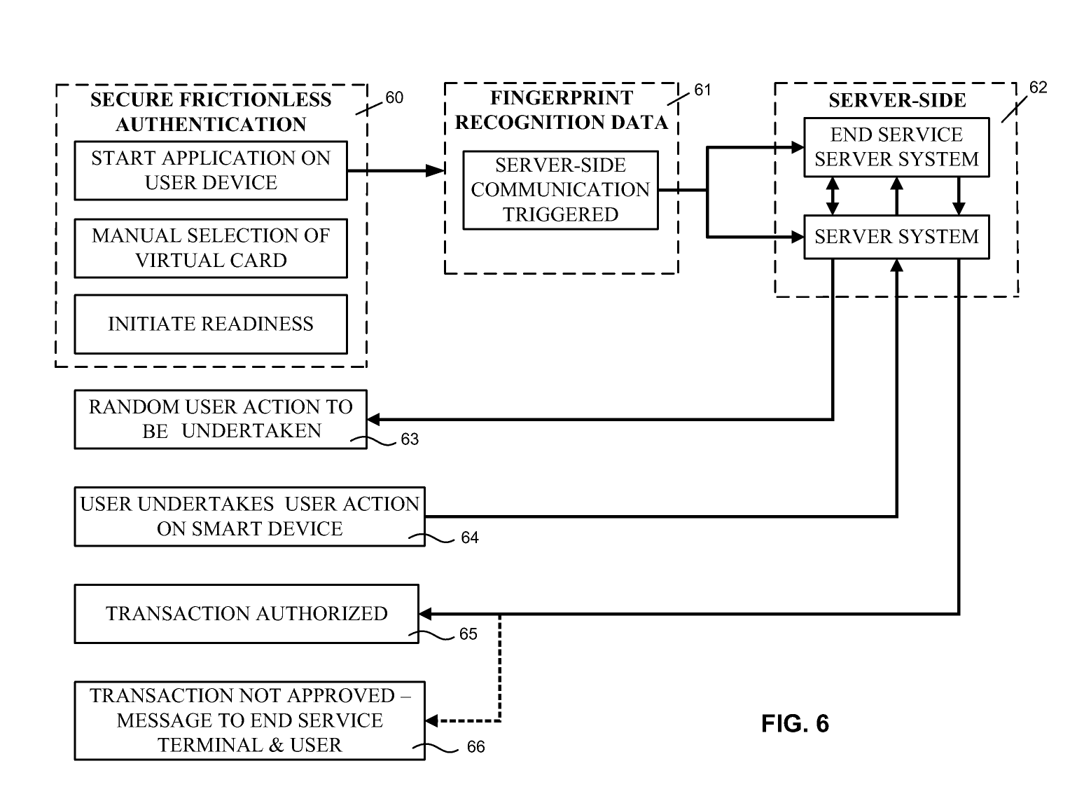

Use Case V (FIG. 6)—Manual Selection of Virtual Card

This use case typifies the situation where the user is remote from the end services terminal, a typical example being an online order and subsequent payment using a credit or bank card. In this situation, the user selects the appropriate virtual card from those stored on the mobile device (60). Information is transmitted to a server through the virtual card application that the selected shall be used. Upon receiving the information, the server determines which end service the user is requesting and prepares the necessary system elements applicable to the particular end service/system required. The remaining process depends on the end service being requested. The process can comprise fingerprint recognition if supported (61); if not, a server system (62) can generate a random “user action” or other unlocking action type as described above (63). Physical actions can be displayed on a display of the user device along with instructions showing the user what he has to do. By completing the required “user action” or other selected unlocking method within a set time-frame (64), the server system is informed that the transaction is authorized (65). If the transaction is not approved, a message is sent to the mobile device (66).

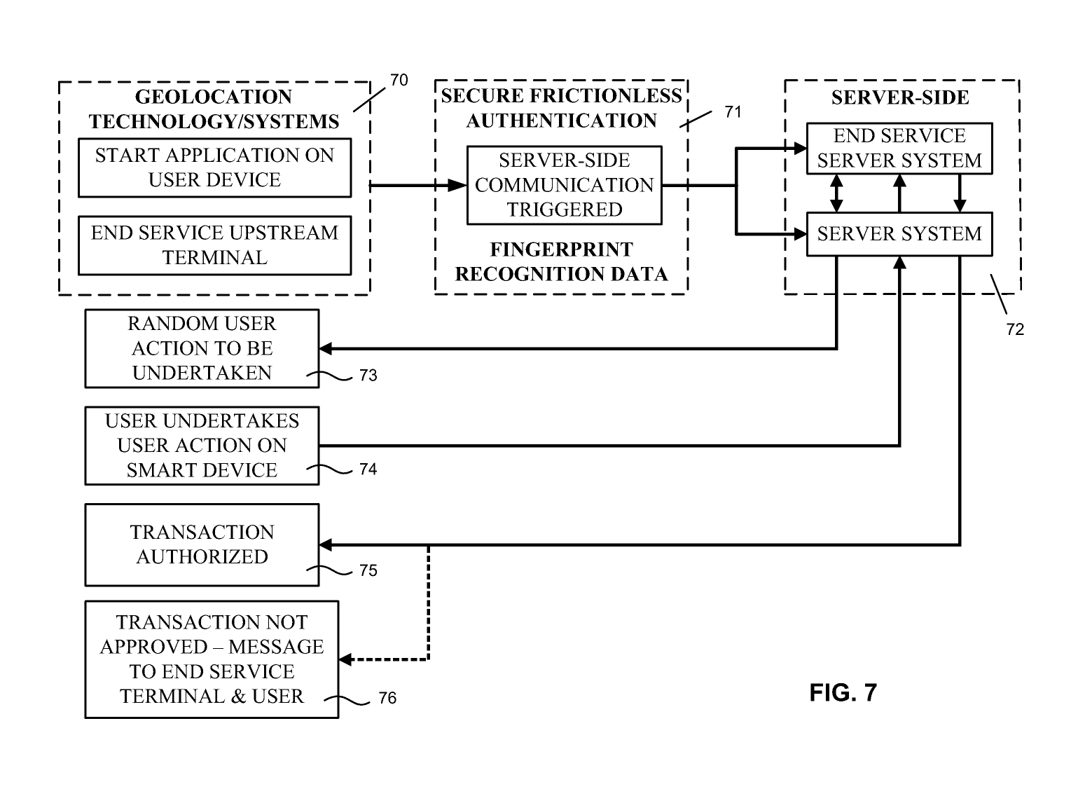

Use Case VI (FIG. 7)—Non-Financial Use—A Library

A user brings his user device (mobile device) with the virtual card into close proximity to a terminal device of a library (70). Secure Frictionless Authentication occurs between the two devices (71). Once the virtual card is connected, the server-side communication between the two parties is triggered (71). Fingerprint recognition can be used (if supported); if not, a server system (72) connected to the terminal device can generate a random “user action” or other unlocking action type as described above (73). Physical actions can be displayed on a display of the user device along with instructions showing the user what he has to do. By completing the required “user action” or other selected unlocking method within a set time-frame (74), the terminal device is be informed that the transaction has been accepted and the lending of the item(s) can proceed (75). If the transaction is not approved, a message is sent to the terminal device and/or the mobile device (76).

Although embodiments of the present invention have been described in detail, it is to be understood that various changes, substitutions and alterations can be made hereto without departing from the spirit and the scope of the invention as defined in the appended claims.

1. A method comprising steps of:
providing a virtual card in a memory of a mobile device, wherein the virtual card comprises user information;
establishing a data connection between the mobile device and a terminal device;
authenticating a user of the virtual card; and
transferring a result of the authentication to the terminal device in order to activate commands of the terminal device.

2. The method of claim 1, wherein the data connection between the mobile device and the terminal device is established when a distance between the mobile device and the terminal device is less than a predetermined value.

3. The method of claim 2, wherein the distance between the mobile device and the terminal device is determined using a geolocation procedure.

4. The method of claim 1, wherein the step of authenticating the user comprises a step of entering a personal identification number.

5. The method of claim 1, wherein the step of authenticating the user comprises a step of entering a password.

6. The method of claim 1, wherein the step of authenticating the user comprises steps of recording and analyzing a fingerprint of the user.

7. The method of claim 1, wherein the step of authenticating the user comprises steps of recording and analyzing a sound sample.

8. The method of claim 1, wherein the step of authenticating the user comprises steps of recording and analyzing a signature of the user.

9. The method of claim 1, wherein the step of authenticating the user comprises steps of recording and analyzing a user action.

10. The method of claim 1, wherein the step of authenticating the user comprises steps of providing an image of the user and analyzing the image.

11. The method of claim 1, wherein the terminal device is adapted to initiate a transfer of money after successful authentication of the user.

12. A method for creating a virtual card, comprising steps of:
recording a digital image of a document;
processing the digital image in order to retrieve user information;
transferring the user information to a server device; and
creating the virtual card by associating the user information with the virtual card.

13. The method of claim 12, further comprising steps of transmitting the virtual card to a mobile device and storing the virtual card in a memory of the mobile device.

14. The method of claim 12, further comprising a step of transferring the digital image to the server device.

15. A computer program product comprising executable instructions stored on a non-transitory computer-readable medium wherein the instructions, when executed by a processor, cause the processor to perform steps of:
providing a virtual card in a memory of a mobile device, wherein the virtual card comprises user information;
establishing a data connection between the mobile device and a terminal device;
authenticating a user of the virtual card; and
transferring a result of the authentication to the terminal device in order to activate commands of the terminal device.
